(19) United States
(12) Patent Application Publication
(10) Pub. No.: US 2021/0050998 A1
(43) Pub. Date: Feb. 18, 2021

(54) SECRET KEY UPDATING SYSTEM, SECRET KEY UPDATING METHOD, AND SECRET KEY UPDATING PROGRAM

(71) Applicant: NEC Corporation, Minato-ku, Tokyo (JP)

(72) Inventor: Tsubasa MATSUDA, Tokyo (JP)

(73) Assignee: NEC Corporation, Minato-ku, Tokyo (JP)

(21) Appl. No.: 16/979,679

(22) PCT Filed: Jan. 23, 2019
(86) PCT No.: PCT/JP2019/002053

§ 371 Date: Sep. 10, 2020

(30) Foreign Application Priority Data
Mar. 15, 2018 (JP) 2018-047442

(51) Int. Cl. H04L 9/08; G06F 21/57; H04L 9/16

(52) U.S. Cl. CPC H04L 9/088; G06F 2221/033; H04L 9/16; G06F 21/577

(57) ABSTRACT

An updating determination means 92 determines whether or not a device is a key updating target device, a secret key of which needs to be updated, based on information acquired from the device and information acquired from a vulnerability information collection means 91. A vulnerability countermeasure completion determination means 93 determines whether or not a countermeasure for vulnerability of an application installed in the device is completed. The updating determination means 92 updates the secret key of the device in a case in which it is determined that the device is the key updating target device, and in which it is determined by the vulnerability countermeasure completion determination means 93 that the countermeasure for the vulnerability of the application is completed.

### TECHNICAL FIELD

The present invention relates to a secret key updating system, a secret key updating method, and a secret key updating program for updating a secret key that a device possesses.

### Background Art

To operate encryption safely, a secret key needs to be managed in an appropriate manner. In a case in which the secret key is not safe, this may cause a risk that encrypted data is intercepted by a malicious third party. The factors that compromise the encryption are a compromise of an encryption algorithm and leakage of a secret key. One of the factors of the leakage of the secret key is vulnerability of an application installed in a device that possesses the secret key. An example of the vulnerability is HeartBleed vulnerability in OpenSSL (Secure Sockets Layer), and this vulnerability may cause a risk that secret key information is decrypted.

Also, PTL 1 describes a system that performs re-encryption by means of a control signal for re-encryption.

### CITATION LIST

### Patent Literature

PTL 1: Japanese Patent No. 5964460

### SUMMARY OF INVENTION

### Technical Problem

In the system described in PTL 1, the re-encryption is triggered by reception of the control signal for re-encryption.

Consider a case in which attention is focused on a secret key that a device possesses. Preferably, when a risk of leakage of the secret key is generated, this triggers updating of the secret key that the device possesses. However, even in such a case, in a case in which the risk of leakage of the secret key remains, there is a possibility of leakage of the updated secret key.

Also, it cannot be determined whether or not the secret key that the device uses is a leaked key. Therefore, in a case in which the risk of leakage of the secret key remains, a risk that an attacker using the leaked secret key spoofs cannot be eliminated.

An object of the present invention is to provide a secret key updating system, a secret key updating method, and a secret key updating program for, in a case in which a risk of leakage of a secret key is generated, enabling the secret key to be updated in a state in which there is no risk of leakage of the updated secret key.

### Solution to Problem

A secret key updating system according to the present invention includes a vulnerability information collection means collecting information about vulnerability of an application, an updating determination means acquiring information about an application from a device in which the application is installed, acquiring the information about the vulnerability of the application from the vulnerability information collection means, and determining whether or not the device is a key updating target device, a secret key of which needs to be updated, based on the information acquired from the device and the information acquired from the vulnerability information collection means, and a vulnerability countermeasure completion determination means determining whether or not a countermeasure for the vulnerability of the application installed in the device is completed. The updating determination means updates the secret key of the device in a case in which it is determined that the device is the key updating target device, and in which it is determined by the vulnerability countermeasure completion determination means that the countermeasure for the vulnerability of the application is completed.

Also, a secret key updating method according to the present invention includes a vulnerability information collection means' collecting information about vulnerability of an application, an updating determination means' acquiring information about an application from a device in which the application is installed, acquiring the information about the vulnerability of the application from the vulnerability information collection means, and determining whether or not the device is a key updating target device, a secret key of which needs to be updated, based on the information acquired from the device and the information acquired from the vulnerability information collection means, and a vulnerability countermeasure completion determination means' determining whether or not a countermeasure for the vulnerability of the application installed in the device is completed. The updating determination means updates the secret key of the device in a case in which it is determined that the device is the key updating target device, and in which it is determined by the vulnerability countermeasure completion determination means that the countermeasure for the vulnerability of the application is completed.

Further, a secret key updating program according to the present invention causes a computer to execute a vulnerability information collection process for collecting information about vulnerability of an application, an updating determination process for acquiring information about an application from a device in which the application is installed and determining whether or not the device is a key updating target device, a secret key of which needs to be updated, based on the information acquired from the device and the information acquired in the vulnerability information collection process, a vulnerability countermeasure completion determination process for determining whether or not a countermeasure for the vulnerability of the application installed in the device is completed, and a key updating process for updating the secret key of the device in a case in which it is determined in the updating determination process that the device is the key updating target device, and in which it is determined in the vulnerability countermeasure completion determination process that the countermeasure for the vulnerability of the application is completed.

### Advantageous Effects of Invention

According to the present invention, in a case in which a risk of leakage of a secret key is generated, the secret key can be updated in a state in which there is no risk of leakage of the updated secret key.

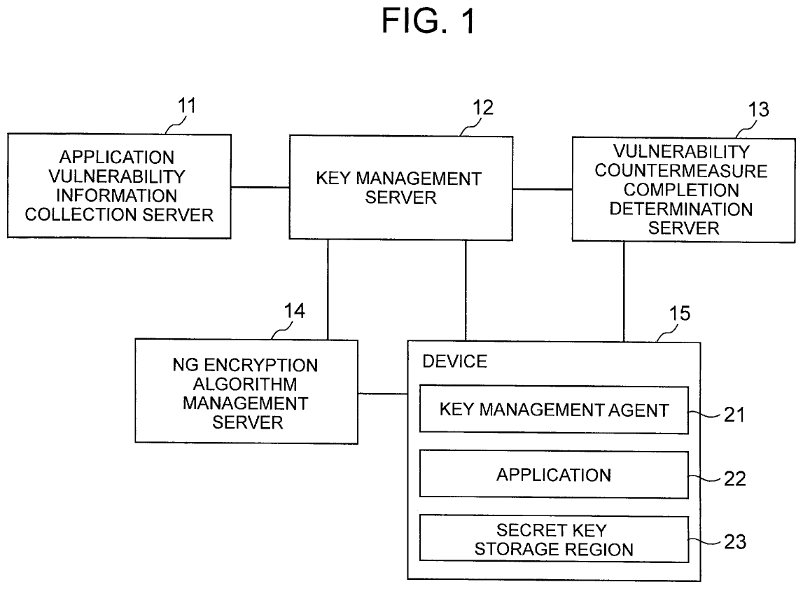

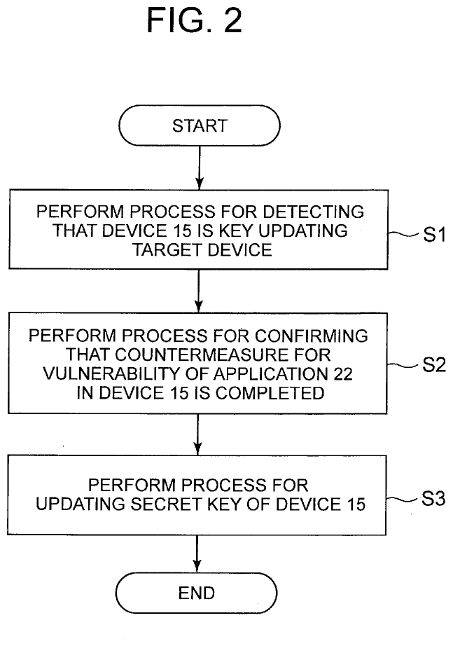

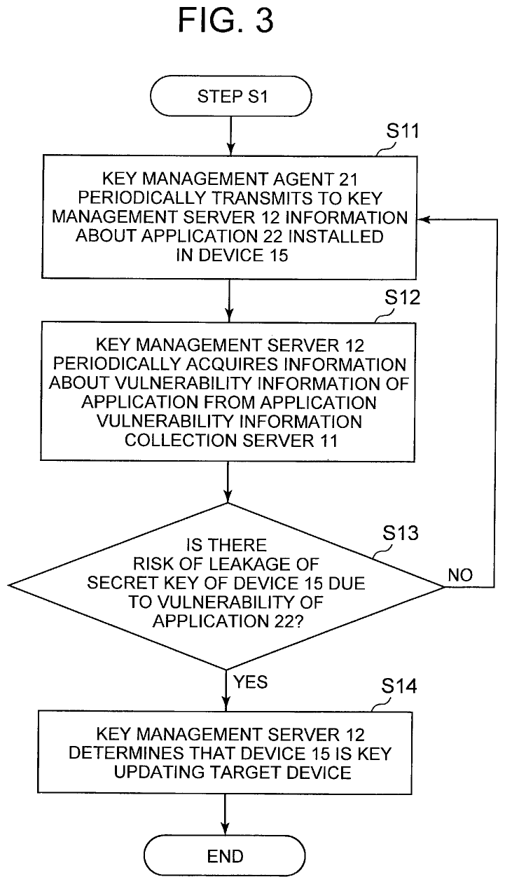

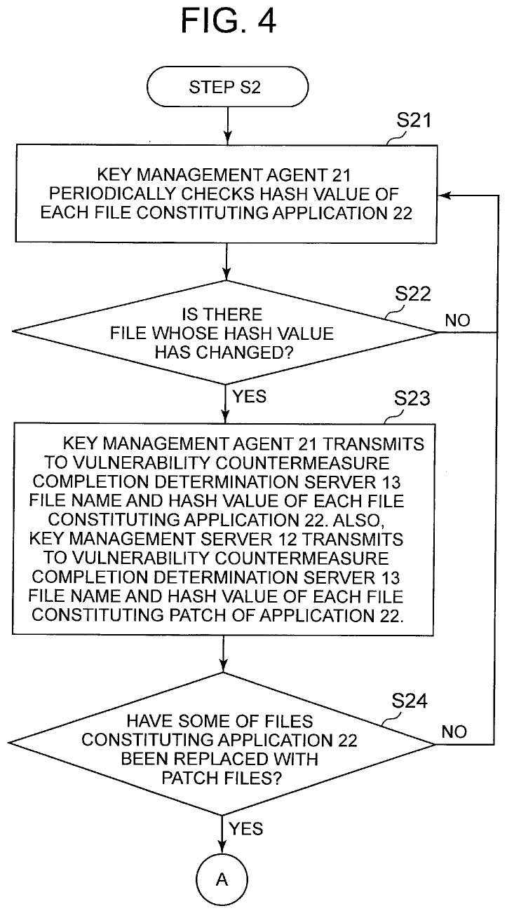

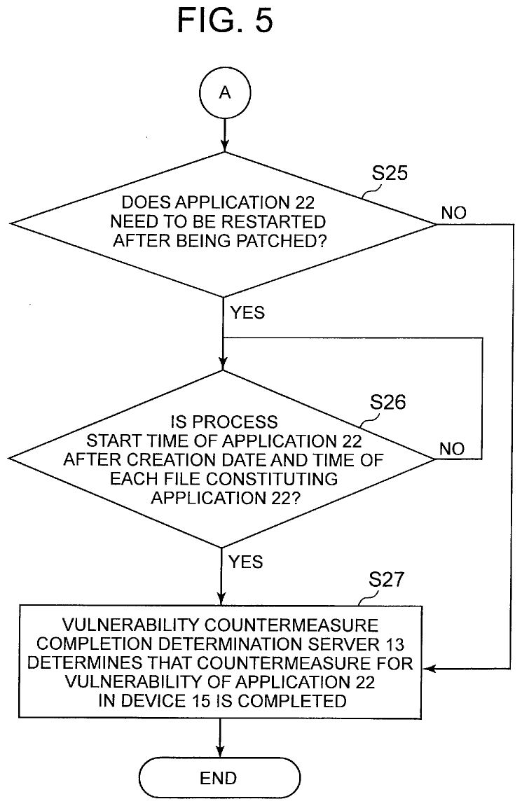

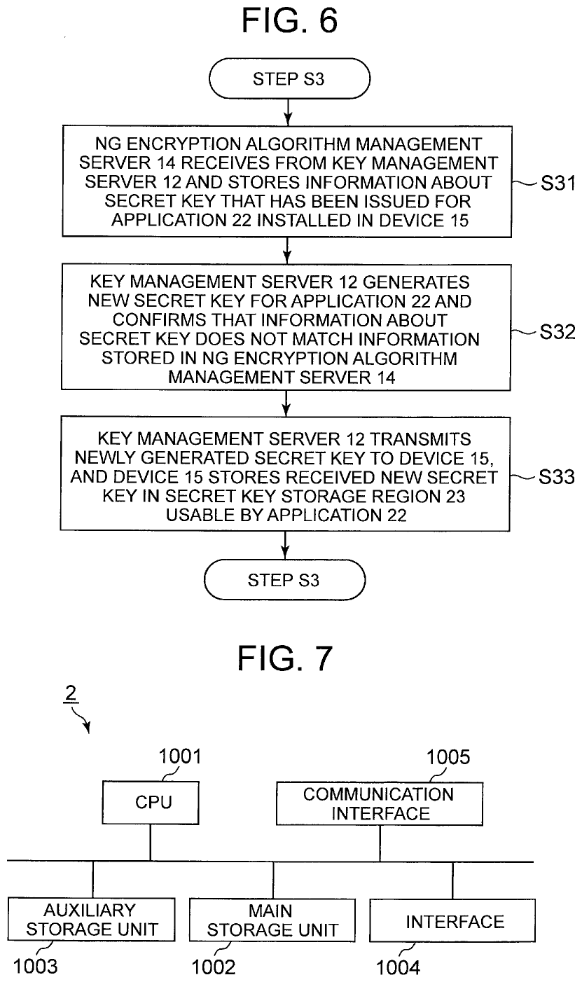

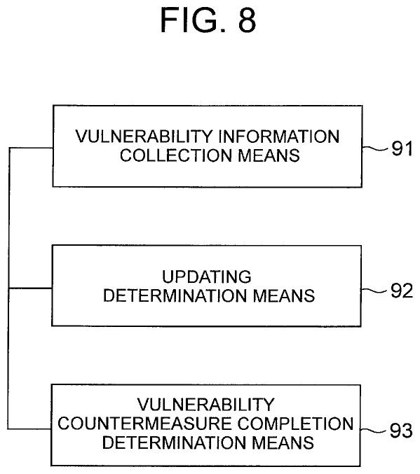

### BRIEF DESCRIPTION OF DRAWINGS

[FIG. 1] It depicts a block diagram illustrating an example of a secret key updating system according to the present invention.

[FIG. 2] It depicts a flowchart illustrating an example of a process procedure according to an exemplary embodiment of the present invention.

[FIG. 3] It depicts a flowchart illustrating an example of a process in step S1.

[FIG. 4] It depicts a flowchart illustrating an example of a process in step S2.

[FIG. 5] It depicts a flowchart illustrating an example of the process in step S2.

[FIG. 6] It depicts a flowchart illustrating an example of a process in step S3.

[FIG. 7] It depicts a schematic block diagram illustrating an example of a computer in a case in which the functions of an application vulnerability information collection server, a key management server, a vulnerability countermeasure completion determination server, and an NG encryption algorithm are fulfilled by one computer.

[FIG. 8] It depicts a block diagram illustrating an overview of a secret key updating system according to the present invention.

### DESCRIPTION OF EMBODIMENTS

Hereinbelow, exemplary embodiments of the present invention will be described with reference to the drawings.

FIG. 1 depicts a block diagram illustrating an example of a secret key updating system according to the present invention. The secret key updating system according to the present invention includes an application vulnerability information collection server 11, a key management server 12, a vulnerability countermeasure completion determination server 13, an NG (No Good) encryption algorithm management server 14, and a device 15. Although one device 15 is illustrated in FIG. 1, the number of the devices 15 is not limited.

The device 15 includes a secret key storage region 23 for storing a secret key. The secret key is issued by the key management server 12. The device 15 also includes a key management agent 21 and an application 22. The key management agent 21 is software, and actually, a processor provided in the device 15 operates in accordance with the key management agent 21. However, the following description will be provided, regarding the operation as the operation of the key management agent 21, for simplicity.

Also, in the present exemplary embodiment, the application is application software.

The application vulnerability information collection server 11 collects information about vulnerability of an application from information published on the Internet.

For example, the application vulnerability information collection server 11 collects and stores, for each application, vulnerability information about the application, a version of a patch applied to the application, a file name of each file (patch file) constituting the patch, a hash value of each file constituting the patch, a hash value of each file constituting the application, a version of the application, and restart necessity information indicating whether or not the application needs to be restarted after being patched.

The vulnerability information about the application is information about security weaknesses of the application. The vulnerability information also includes vulnerability presence/absence information indicating presence/absence of a risk of leakage of a secret key due to the vulnerability of the application.

The file constituting the application is a file used while the application is activated. The number of the files constituting the application is not limited to one. Similarly, the number of the files constituting the patch (patch files) is not limited to one.

The key management server 12 stores information transmitted to the key management server 12 by the key management agent 21 and information acquired from the application vulnerability information collection server 11.

The key management server 12 acquires from the key management agent 21 and stores information about a secret key issued by the key management server 12 to the device 15. Specific examples of the information about the issued secret key are a device name of the device that possesses the secret key (in other words, a device name of the device 15 including the key management agent 21), an encryption algorithm that the application 22 uses, and a key length. The key management server 12 also acquires from the key management agent 21 and stores usage of the secret key. The key management server 12 further acquires from the key management agent 21 and stores an application name of the application 22 included in the device 15, a file name of each file constituting the application 22, a hash value of each file constituting the application 22, and a version of the application 22.

Also, the key management server 12 acquires from the application vulnerability information collection server 11 and stores, for each application, the vulnerability presence/absence information, the version of the patch, the file name of each file constituting the patch, the hash value of each file constituting the patch, the hash value of each file constituting the application, and the restart necessity information.

The vulnerability countermeasure completion determination server 13 stores information transmitted by the key management agent 21 to the vulnerability countermeasure completion determination server 13 and information acquired from the application vulnerability information collection server 11 and the key management server 12.

The vulnerability countermeasure completion determination server 13 acquires from the key management agent 21 and stores the application name of the application 22 included in the device 15, the file name of each file constituting the application 22, and the hash value of each file constituting the application 22.

The vulnerability countermeasure completion determination server 13 also acquires from the key management agent 21 and stores information about creation date and time of each file constituting the application 22 and process start time of the application 22. In a case in which a patch is applied to the application 22, the creation date and time of each file constituting the application 22 also includes creation date and time of the patch file. By comparing the creation date and time of each file constituting the application 22 with the process start time of the application 22, it is possible to determine whether or not the application 22 has been restarted after the patch application.

Note that the process of comparing the creation date and time of each file constituting the application 22 with the process start time of the application 22 may be executed by the vulnerability countermeasure completion determination server 13 or by the key management agent 21. In a case in which the key management agent 21 executes this comparison process, the key management agent 21 does not need to transmit the aforementioned information about the creation date and time and the process start time to the vulnerability countermeasure completion determination server 13. In that case, the key management agent 21 may transmit a result of the above comparison process (comparison result) to the vulnerability countermeasure completion determination server 13.

Also, the vulnerability countermeasure completion determination server 13 acquires from the key management server 12 and stores a file name of each file constituting the patch of the application 22 and a hash value of each file constituting the patch.

Further, the vulnerability countermeasure completion determination server 13 acquires from the application vulnerability information collection server 11 and stores the restart necessity information of the application 22. Meanwhile, the vulnerability countermeasure completion determination server 13 may acquire the restart necessity information of the application 22 from the key management server 12.

In a case in which the application 22 installed in the device 15 is vulnerable, the vulnerability countermeasure completion determination server 13 determines whether or not the countermeasure for the vulnerability of the application 22 is completed based on the acquired information.

In a case in which the application 22 installed in the device 15 is vulnerable, and in which the countermeasure for the vulnerability is completed, the NG encryption algorithm management server 14 receives from the key management agent 21 and stores information (the application name of the application 22, the encryption algorithm that the application 22 uses, and the key length of the secret key) about the secret key before completion of the countermeasure (secret key possessed by the device 15 before completion of the countermeasure). The NG encryption algorithm management server 14 may receive the information about the secret key before completion of the countermeasure for the vulnerability from the key management server 12. A below-mentioned flowchart illustrated in FIG. 6 will be described, taking as an example a case in which the NG encryption algorithm management server 14 receives the information about the secret key before completion of the countermeasure from the key management server 12.

The key management agent 21 stores and transmits to another server the application name of the application 22, the version of the application 22, the file name of each file constituting the application 22, the hash value of each file constituting the application 22, the creation date and time of each file constituting the application 22, the process start time of the application 22, and the like.

Also, in the present exemplary embodiment, in a case in which the application 22 installed in the device 15 is vulnerable, and in which it is determined that the countermeasure for the vulnerability is completed, the key management server 12 generates a new secret key to be issued to the device 15. In a case in which the information about the new secret key does not match the information stored in the NG encryption algorithm management server 14, the key management server 12 updates the secret key that the device 15 possesses with use of the new secret key.

The device 15 operates in accordance with the application 22 and the key management agent 21.

The application vulnerability information collection server 11 operates in accordance with a program for the application vulnerability information collection server 11.

The key management server 12 operates in accordance with a program for the key management server 12.

The vulnerability countermeasure completion determination server 13 operates in accordance with a program for the vulnerability countermeasure completion determination server 13.

The NG encryption algorithm management server 14 operates in accordance with a program for the NG encryption algorithm management server 14.

Next, an example of a process procedure according to the present exemplary embodiment will be described. FIG. 2 depicts a flowchart illustrating an example of a process procedure according to the present exemplary embodiment.

First, the secret key updating system according to the present exemplary embodiment performs a process for detecting that the device 15 is a key updating target device (step S1). The key updating target device is a device a secret key of which needs to be updated, and in a case in which an application installed in the device has a risk of leakage of the secret key, the device corresponds to the key updating target device.

Subsequent to step S1, the secret key updating system performs a process for confirming that the countermeasure for the vulnerability of the application 22 in the device 15 is completed (step S2).

Subsequently, the secret key updating system performs a process for updating the secret key of the device 15 (step S3).

Next, each process in steps S1, S2, and S3 will be described more specifically.

FIG. 3 depicts a flowchart illustrating an example of the process in step S1. It is assumed that the device 15 is operating. In other words, the device 15 is assumed to be operating in accordance with the application 22.

In step S1, the key management agent 21 periodically transmits to the key management server 12 information about the application 22 installed in the device 15 (step S11). The information about the application 22 is the version of the application 22 and the hash value of each file constituting the application 22. That is, the key management agent 21 periodically transmits to the key management server 12 the version of the application 22 and the hash value of each file constituting the application 22. The key management server 12 receives the information each time the key management agent 21 transmits the information (the version of the application 22 and the hash value of each file constituting the application 22).

Also, the key management server 12 periodically acquires information about vulnerability of the application 22 installed in the device 15 from the application vulnerability information collection server 11 (step S12). The information about vulnerability of the application 22 is the version of the application 22, the hash value of each file constituting the application 22, and the vulnerability presence/absence information of the application 22. That is, the key management server 12 periodically acquires the version of the application 22, the hash value of each file constituting the application 22, and the vulnerability presence/absence information of the application 22 from the application vulnerability information collection server 11.

Subsequently, the key management server 12 determines whether or not there is a risk of leakage of the secret key of the device 15 due to the vulnerability of the application 22 (step S13). In step S13, the key management server 12 determines that there is a risk of leakage of the secret key of the device 15 due to the vulnerability of the application 22 in a case in which the version and each of the hash values received from the key management agent 21 in step S11 match the version and each of the hash values acquired from the application vulnerability information collection server 11 in step S12, and in which the vulnerability presence/absence information acquired in step S12 satisfies conditions indicating that there is the risk of leakage of the secret key due to the vulnerability of the application 22. Also, the key management server 12 determines that there is no risk of leakage of the secret key of the device 15 due to the vulnerability of the application 22 in a case in which the conditions are not satisfied.

In a case in which the key management server 12 determines that there is no risk of leakage of the secret key of the device 15 due to the vulnerability of the application 22 (No in step S13), the processes in step S11 and the subsequent steps are repeated.

Also, in a case in which the key management server 12 determines that there is a risk of leakage of the secret key of the device 15 due to the vulnerability of the application 22 (Yes in step S13), the key management server 12 determines that the device 15 is a key updating target device (step S14). In step S14, step Si ends.

FIGS. 4 and 5 depict flowcharts illustrating an example of the process in step S2.

For example, after step S1, when the key management server 12 notifies the key management agent 21 that the device 15 is determined to be the key updating target device, the process in step S2 is started.

In step S2, the key management agent 21 periodically checks the hash value of each file constituting the application 22 installed in the device 15 (step S21) and determines whether or not there is a file whose hash value has changed (step S22). In a case in which there is no file whose hash value has changed (No in step S22), the processes in step S21 and the subsequent steps are repeated.

In a case in which there is a file whose hash value has changed (Yes in step S22), some of the files constituting the application 22 may have been replaced with patch files (that is, the application 22 may have been patched). In steps S23 and S24 described below, it is confirmed whether or not the application 22 has been patched.

In a case in which there is a file whose hash value has changed (Yes in step S22), the key management agent 21 transmits to the vulnerability countermeasure completion determination server 13 the file name and the hash value of each file constituting the application 22 installed in the device 15. Also, the key management server 12 transmits to the vulnerability countermeasure completion determination server 13 the file name and the hash value of each file constituting the patch of the application 22 (step S23). Meanwhile, the key management server 12 may acquire in advance from the application vulnerability information collection server 11 the file name and the hash value of each file constituting the patch of the application 22. In a case in which the key management server 12 receives from the key management agent 21 a notification that there is a file whose hash value has changed, the key management server 12 may transmits to the vulnerability countermeasure completion determination server 13 the file name and the hash value of each file constituting the patch of the application 22.

The vulnerability countermeasure completion determination server 13 collates the information (file names and hash values) received from the key management agent 21 in step S23 with the information (file names and hash values) received from the key management server 12 in step S23 to determine whether or not some of the files constituting the application 22 installed in the device 15 have been replaced with patch files (step S24). For example, in a case in which the sets each consisting of a file name and a hash value received from the key management server 12 are contained in the sets each consisting of a file name and a hash value received from the key management agent 21, the vulnerability countermeasure completion determination server 13 determines that some of the files constituting the application 22 have been replaced with patch files, and otherwise, the vulnerability countermeasure completion determination server 13 determines that none of the files constituting the application 22 have been replaced with patch files.

In a case in which it is determined that none of the files constituting the application 22 have been replaced with patch files (in other words, the application 22 has not been patched) (No in step S24), the processes in step S21 and the subsequent steps are repeated.

In a case in which it is determined that some of the files constituting the application 22 have been replaced with patch files (in other words, the application 22 has been patched) (Yes in step S24), the processing moves to step S25 (refer to FIG. 5). In the present example, at this time, the vulnerability countermeasure completion determination server 13 notifies the key management agent 21 that the application 22 has been patched.

In step S25, the key management agent 21 inquires of the vulnerability countermeasure completion determination server 13 for whether or not the application 22 is an application that needs to be restarted after being patched. The vulnerability countermeasure completion determination server 13 may refer to the restart necessity information corresponding to the application 22 to notify the key management agent 21 of whether or not the application 22 is an application that needs to be restarted after being patched.

In a case in which the application 22 is an application that does not need to be restarted after being patched (No in step S25), the vulnerability countermeasure completion determination server 13 determines that the countermeasure for the vulnerability of the application 22 in the device 15 is completed (step S27). That is, in a case in which the vulnerability countermeasure completion determination server 13 has determined that the application 22 is an application that does not need to be restarted after being patched, the vulnerability countermeasure completion determination server 13 may determine that the countermeasure for the vulnerability of the application 22 in the device 15 is completed.

In a case in which the application 22 is an application that needs to be restarted after being patched (Yes in step S25), the key management agent 21 compares the process start time of the application 22 in the device 15 with the creation date and time of each file constituting the application 22 to determine whether or not the process start time of the application 22 is after the creation date and time of each file (step S26). The key management agent 21 notifies the vulnerability countermeasure completion determination server 13 of a determination result in step S26 (whether or not the process start time is after the creation date and time of each file). The process start time of the application 22 being after the creation date and time of each file means that the application 22 has been restarted after being patched. Also, in a case in which the condition that the process start time is after the creation date and time of each file is not satisfied, the case means that the application 22 has not been restarted after being patched.

In a case in which the condition that the process start time is after the creation date and time of each file is not satisfied (No in step S26), the key management agent 21 repeats the comparison process in step S26. In a case in which the process start time is after the creation date and time of each file (Yes in step S26), the vulnerability countermeasure completion determination server 13 determines as a result of receiving the notification that the application 22 has been restarted after being patched. The vulnerability countermeasure completion determination server 13 then determines that the countermeasure for the vulnerability of the application 22 in the device 15 is completed (step S27). In step S27, step S2 described above ends.

In the above example, the case in which, in step S25, the key management agent 21 inquires of the vulnerability countermeasure completion determination server 13 for whether or not the application 22 is an application that needs to be restarted after being patched has been described as an example. In step S25, the vulnerability countermeasure completion determination server 13 may determine whether or not the application 22 is an application that needs to be restarted after being patched.

Also, in the above example, the case in which, in step S26, the key management agent 21 compares the process start time of the application 22 in the device 15 with the creation date and time of each file constituting the application 22 to determine whether or not the process start time of the application 22 is after the creation date and time of each file has been described as an example. In step S26, the vulnerability countermeasure completion determination server 13 may compare the process start time of the application 22 with the creation date and time of each file constituting the application 22 to determine whether or not the process start time of the application 22 is after the creation date and time of each file. In this case, for example, the vulnerability countermeasure completion determination server 13 may notify the key management agent 21 that the application 22 has been patched, and in response to this notification, the key management agent 21 may transmit to the vulnerability countermeasure completion determination server 13 the process start time of the application 22 and the creation date and time of each file constituting the application 22.

FIG. 6 depicts a flowchart illustrating an example of the process in step S3. Note that, when step S2 ends, the vulnerability countermeasure completion determination server 13 notifies the key management server 12 that the countermeasure for the vulnerability of the application 22 in the device 15 has been completed.

Upon receiving this notification, the key management server 12 transmits the information about the secret key before completion of the countermeasure for the vulnerability of the application 22 (in other words, the secret key that has been issued for the application 22) to the NG encryption algorithm management server 14. The NG encryption algorithm management server 14 then receives and stores the information (step S31). The information about the secret key before completion of the countermeasure for the vulnerability of the application 22 includes the application name of the application 22, the encryption algorithm that the application 22 uses, and the key length of the issued secret key.

Subsequently, the key management server 12 generates a new secret key for the application 22 installed in the device 15 and confirms that information about the secret key (a set of an application name of the application 22, an encryption algorithm that the application 22 uses, and a key length of the new secret key) does not match the information stored in the NG encryption algorithm management server 14 (step S32). In a case in which they match, the key management server 12 may execute step S32 again.

After step S32, the key management server 12 updates the secret key that the device 15 possesses with use of the newly generated secret key. That is, the key management server 12 transmits the newly generated secret key to the device 15, and the device 15 stores the received new secret key in the secret key storage region 23 usable by the application 22 (step S33). In step S33, step S3 described above ends.

According to the present exemplary embodiment, the key management server 12 determines that the device 15 is the key updating target device, and after the vulnerability countermeasure completion determination server 13 determines that the countermeasure for the vulnerability of the application 22 is completed, the key management server 12 updates the secret key of the device 15. Therefore, in a case in which a risk of leakage of the secret key of the device 15 is generated, the secret key of the device can be updated. Also, since the key management server 12 updates the secret key after it is determined that the countermeasure for the vulnerability of the application 22 installed in the device 15 is completed, there is no risk of leakage of the updated secret key. That is, according to the present exemplary embodiment, in a case in which a risk of leakage of a secret key is generated, the secret key can be updated in a state in which there is no risk of leakage of the updated secret key.

Also, according to the present exemplary embodiment, the key management server 12 updates the secret key of the device 15 with use of the new secret key after it is confirmed that the information about the newly generated secret key does not match the information about the previously issued secret key (the secret key before the countermeasure for the vulnerability is completed). Therefore, from this respect as well, a risk of leakage of the updated secret key can be reduced.

Also, in the above exemplary embodiment, the case in which the application vulnerability information collection server 11, the key management server 12, the vulnerability countermeasure completion determination server 13, and the NG encryption algorithm 14 are separate servers has been described (refer to FIG. 1). Instead of these respective servers, one computer having the functions of these respective servers may be provided. That is, the functions of the application vulnerability information collection server 11, the key management server 12, the vulnerability countermeasure completion determination server 13, and the NG encryption algorithm 14 may be fulfilled by a central processing unit (CPU) of the computer that operates in accordance with a secret key updating program. For example, the CPU of the computer may read the secret key updating program from a program recording medium such as a program storage unit of the computer and perform similar operations to those of the application vulnerability information collection server 11, the key management server 12, the vulnerability countermeasure completion determination server 13, and the NG encryption algorithm 14 in accordance with the secret key updating program.

FIG. 7 depicts a schematic block diagram illustrating an example of a computer in a case in which the functions of the application vulnerability information collection server 11, the key management server 12, the vulnerability countermeasure completion determination server 13, and the NG encryption algorithm 14 are fulfilled by one computer. A computer 2 includes a CPU 1001, a main storage unit 1002, an auxiliary storage unit 1003, an interface 1004, and a communication interface 1005. The communication interface 1005 is a communication interface for communicating with the device 15.

The functions of the application vulnerability information collection server 11, the key management server 12, the vulnerability countermeasure completion determination server 13, and the NG encryption algorithm 14 are implemented in the computer 2. The operation of the computer 2 is stored in the auxiliary storage unit 1003 in a form of the secret key updating program. The CPU 1001 reads the secret key updating program from the auxiliary storage unit 1003, expands the program on the main storage unit 1002, and performs similar operations to those of the application vulnerability information collection server 11, the key management server 12, the vulnerability countermeasure completion determination server 13, and the NG encryption algorithm 14 in accordance with the secret key updating program.

The auxiliary storage unit 1003 is an example of a not-temporary tangible medium. Other examples of the not-temporary tangible medium are a magnetic disk, a magneto-optical disk, a compact disk read only memory (CD-ROM), a digital versatile disk read only memory (DVD-ROM), and a semiconductor memory connected via the interface 1004. Also, in a case in which the program is delivered to the computer 2 via communication lines, the computer 2 may receive the program, expand the program on the main storage unit 1002, and operate in accordance with the program.

Next, an overview of the present invention will be described. FIG. 8 depicts a block diagram illustrating an overview of a secret key updating system according to the present invention. The secret key updating system according to the present invention includes a vulnerability information collection means 91, an updating determination means 92, and a vulnerability countermeasure completion determination means 93.

The vulnerability information collection means 91 (for example, the application vulnerability information collection server 11) collects information about vulnerability of an application.

The updating determination means 92 (for example, the key management server 12) acquires information about an application (for example, the application 22) from a device (for example, the device 15) in which the application is installed, acquires the information about the vulnerability of the application from the vulnerability information collection means 91, and determines whether or not the device is a key updating target device, a secret key of which needs to be updated, based on the information acquired from the device and the information acquired from the vulnerability information collection means 91.

The vulnerability countermeasure completion determination means 93 (for example, the vulnerability countermeasure completion determination server 13) determines whether or not a countermeasure for the vulnerability of the application installed in the device is completed.

Also, the updating determination means 92 updates the secret key of the device in a case in which it is determined that the device is the key updating target device, and in which it is determined by the vulnerability countermeasure completion determination means 93 that the countermeasure for the vulnerability of the application is completed.

With such a configuration, in a case in which a risk of leakage of a secret key is generated, the secret key can be updated in a state in which there is no risk of leakage of the updated secret key.

Also, in a case in which the application is an application that does not need to be restarted after a file of the application is replaced with a patch file, the vulnerability countermeasure completion determination means 93 may determine that the countermeasure for the vulnerability of the application is completed when the file of the application is replaced with the patch file, and in a case in which the application is an application that needs to be restarted after a file of the application is replaced with a patch file, the vulnerability countermeasure completion determination means 93 may determine that the countermeasure for the vulnerability of the application is completed when the file of the application is replaced with the patch file, and when the application has been restarted.

Also, a secret key information storage means (for example, the NG encryption algorithm management server 14) may be provided which, in a case in which the countermeasure for the vulnerability of the application is completed, stores information about the secret key before completion of the countermeasure, and in a case in which it is determined that the device is the key updating target device, in which it is determined by the vulnerability countermeasure completion determination means 93 that the countermeasure for the vulnerability of the application is completed, and in which information about a newly generated secret key does not match the information stored in the secret key information storage means, the updating determination means 92 may update the secret key of the device with use of the newly generated secret key.

Also, the updating determination means 92 may acquire from the device as information about the application a version of the application and a hash value of a file used while the application is activated, acquire from the vulnerability information collection means 91 as information about the vulnerability of the application a version of the application, a hash value of a file used while the application is activated, and vulnerability presence/absence information indicating presence/absence of a risk of leakage of the secret key due to the application, and determine whether or not the device is the key updating target device, the secret key of which needs to be updated, based on the information acquired from the device and the information acquired from the vulnerability information collection means 91.

Although the invention of the present application has been described above with reference to the exemplary embodiments, the invention of the present application is not limited to the above exemplary embodiments. The configurations and the details of the invention of the present application can be altered in various ways so as to be understandable by those skilled in the art within the scope of the invention of the present application.

The present application is based on and claims priority to Japanese Patent Application No. 2018-047442, filed on Mar. 15, 2018, the entire disclosure of which is hereby incorporated herein.

### INDUSTRIAL APPLICABILITY

The present invention is preferably applied to a secret key updating system for updating a secret key.

### REFERENCE SIGNS LIST

11 Application vulnerability information collection server
12 Key management server
13 Vulnerability countermeasure completion determination server
14 NG encryption algorithm management server
15 Device
21 Key management agent
22 Application
23 Secret key storage region

What is claimed is:

1. A secret key updating system comprising:
a vulnerability information collection unit collecting information about vulnerability of an application;
an updating determination unit acquiring information about an application from a device in which the application is installed, acquiring the information about the vulnerability of the application from the vulnerability information collection unit and determining whether or not the device is a key updating target device, a secret key of which needs to be updated, based on the information acquired from the device and the information acquired from the vulnerability information collection unit; and
a vulnerability countermeasure completion determination unit determining whether or not a countermeasure for the vulnerability of the application installed in the device is completed,
wherein the updating determination unit updates the secret key of the device in a case in which it is determined that the device is the key updating target device, and in which it is determined by the vulnerability countermeasure completion determination unit that the countermeasure for the vulnerability of the application is completed.

2. The secret key updating system according to claim 1, wherein, in a case in which the application is an application that does not need to be restarted after a file of the application is replaced with a patch file, the vulnerability countermeasure completion determination unit determines that the countermeasure for the vulnerability of the application is completed when the file of the application is replaced with the patch file, and
wherein, in a case in which the application is an application that needs to be restarted after a file of the application is replaced with a patch file, the vulnerability countermeasure completion determination unit determines that the countermeasure for the vulnerability of the application is completed when the file of the application is replaced with the patch file, and when the application has been restarted.

3. The secret key updating system according to claim 1 comprising:
a secret key information storage unit, in a case in which the countermeasure for the vulnerability of the application is completed, storing information about the secret key before completion of the countermeasure,
wherein, in a case in which it is determined that the device is the key updating target device, in which it is determined by the vulnerability countermeasure completion determination unit that the countermeasure for the vulnerability of the application is completed, and in which information about a newly generated secret key does not match the information stored in the secret key information storage moans, unit, the updating determination moans unit updates the secret key of the device with use of the newly generated secret key.

4. The secret key updating system according to claim 1, wherein the updating determination unit
acquires from the device as information about the application a version of the application and a hash value of a file used while the application is activated,
acquires from the vulnerability information collection unit as information about the vulnerability of the application a version of the application, a hash value of a file used while the application is activated, and vulnerability presence/absence information indicating presence/absence of a risk of leakage of the secret key due to the application, and
determines whether or not the device is the key updating target device, the secret key of which needs to be updated, based on the information acquired from the device and the information acquired from the vulnerability information collection unit.

5. A secret key updating method comprising:
a vulnerability information collection unit' collecting information about vulnerability of an application;
an updating determination unit' acquiring information about an application from a device in which the application is installed, acquiring the information about the vulnerability of the application from the vulnerability information collection unit and determining whether or not the device is a key updating target device, a secret key of which needs to be updated, based on the information acquired from the device and the information acquired from the vulnerability information collection unit; and
a vulnerability countermeasure completion determination unit' determining whether or not a countermeasure for the vulnerability of the application installed in the device is completed,
wherein the updating determination unit updates the secret key of the device in a case in which it is determined that the device is the key updating target device, and in which it is determined by the vulnerability countermeasure completion determination unit that the countermeasure for the vulnerability of the application is completed.

6. The secret key updating method according to claim 5, wherein, in a case in which the application is an application that does not need to be restarted after a file of the application is replaced with a patch file, the vulnerability countermeasure completion determination unit determines that the countermeasure for the vulnerability of the application is completed when the file of the application is replaced with the patch file, and
wherein, in a case in which the application is an application that needs to be restarted after a file of the application is replaced with a patch file, the vulnerability countermeasure completion determination unit determines that the countermeasure for the vulnerability of the application is completed when the file of the application is replaced with the patch file, and when the application has been restarted.

7. The secret key updating method according to claim 5, comprising:
a secret key information storage unit', in a case in which the countermeasure for the vulnerability of the application is completed, storing information about the secret key before completion of the countermeasure,
wherein, in a case in which it is determined that the device is the key updating target device, in which it is determined by the vulnerability countermeasure completion determination unit that the countermeasure for the vulnerability of the application is completed, and in which information about a newly generated secret key does not match the information stored in the secret key information storage unit, the updating determination unit updates the secret key of the device with use of the newly generated secret key.

8. The secret key updating method according to claim 5, wherein the updating determination unit
acquires from the device as information about the application a version of the application and a hash value of a file used while the application is activated,
acquires from the vulnerability information collection unit as information about the vulnerability of the application a version of the application, a hash value of a file used while the application is activated, and vulnerability presence/absence information indicating presence/absence of a risk of leakage of the secret key due to the application, and
determines whether or not the device is the key updating target device, the secret key of which needs to be updated, based on the information acquired from the device and the information acquired from the vulnerability information collection unit.

9. A non-transitory computer-readable recording medium in which a secret key updating program is recorded, the secret key updating program causing a computer to execute:
a vulnerability information collection process for collecting information about vulnerability of an application;
an updating determination process for acquiring information about an application from a device in which the application is installed and determining whether or not the device is a key updating target device, a secret key of which needs to be updated, based on the information acquired from the device and the information acquired in the vulnerability information collection process;
a vulnerability countermeasure completion determination process for determining whether or not a countermeasure for the vulnerability of the application installed in the device is completed; and
a key updating process for updating the secret key of the device in a case in which it is determined in the updating determination process that the device is the key updating target device, and in which it is determined in the vulnerability countermeasure completion determination process that the countermeasure for the vulnerability of the application is completed.
